(19) United States
(12) Patent Application Publication
(10) Pub. No.: US 2014/0279079 A1
(43) Pub. Date: Sep. 18, 2014

(54) METHOD AND USER INTERFACE FOR CLASSIFYING MEDIA ASSETS

(71) Applicant: THOMSON LICENSING, Issy de Moulineaux (FR)

(72) Inventors: Gregory David Gudorf, San Diego, CA (US); Stelian Markov, La Crescenta, CA (US); Samir M. Ahmed, Culver City, CA (US); Praneeth Kongara, Los Angeles, CA (US)

(73) Assignee: Thomson Licensing

(21) Appl. No.: 14/350,642

(22) PCT Filed: Oct. 11, 2012
(86) PCT No.: PCT/US12/59751

§ 371 Date: Apr. 9, 2014

Related U.S. Application Data
(60) Provisional application No. 61/546,025, filed on Oct. 11, 2011.

(51) Int. Cl. G06F 17/30; G06Q 30/02

(52) U.S. Cl. CPC G06F 17/30598; G06Q 30/0277
USPC 705/14.73; 707/737

(57) ABSTRACT

The present disclosure is directed towards grouping together media assets that are stored in different locations. Media assets are identified as having common classification by using the metadata associated with such media assets (420). Additional media assets are also added to such storage locations automatically (430), where the additional media assets share the same classifications as the previously classified media assets. Optionally, offers (425) are provided to a user based on such classification operations.

The present application claims priority from U.S. Provisional Application Ser. No. 61/546,025 that was filed on Oct. 11, 2011, which is incorporated by reference herein its entirety.

### FIELD OF THE INVENTION

The present disclosure relates generally to digital lockers, and more specifically to a user interface that is used for managing the content of digital lockers residing in different locations.

### BACKGROUND OF THE INVENTION

With the growth of storage services known as digital lockers and the presence of media stored on consumption devices by a user, it is possible for a user to have media content stored in multiple locations. Such a user can have difficulty keeping track of such content because digital locker services and local/remote storage devices can have a file format or front end that varies from service to service and device to device. A user can also have difficulty buying new content at a discount because offers made to the user are only going to pertain to a specific digital locker or media service.

### SUMMARY OF THE INVENTION

A method and apparatus is described for automatically grouping together media assets that are stored in different locations. Media assets are classified together by determining how corresponding metadata for each media asset are related. Additional media assets are automatically added to such locations because the additional media assets share a classification with the media assets that were previously grouped.

### DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 is a block diagram of an exemplary system of a media delivery and consumption system in accordance with an embodiment of the present disclosure;

FIG. 2 is a block diagram of an exemplary consumption device in accordance with an embodiment of the present disclosure;

FIG. 3 is a perspective view of an exemplary media device in accordance with an embodiment of the present disclosure;

FIG. 4 is a flowchart of an exemplary method for classifying media assets stored in different locations in accordance with an embodiment of the present disclosure;

FIG. 5 illustrates an exemplary embodiment of a user interface that shows the location of various media assets accordance with the present disclosure; and

FIG. 6 illustrates an exemplary embodiment of a user interface that shows the classification of various media assets that are grouped together in accordance with the present disclosure.

### DESCRIPTION OF THE PREFERRED EMBODIMENTS

For purposes of this specification, the term digital locker can be a storage server where a user can store media content remotely or locally. A digital locker can also be a digital rights service where a user has the ability to use content from such a service. An example of a digital rights service is but is not limited to ULTRAVIOLET and the like.

Different fields are introduced below where such generic fields are used to indicate different properties about a media asset, media service, digital locker service and the like. The fields are described in this application are detonated by the use of a “tag” in the form of <<FIELD>>. Particular attributes for such fields can be added using various separations as indicated <<FIELD&ATTRIBUTE1 &ATTRIBUTE2 &ATTRIBUTE3 . . . >. It is understood that fields and attributes can also be constructed where a particular hash combination (MD5, SHA1, and the like) can represent the contents of a field and associated attributes.

Other implementations can be performed in accordance with the disclosed principles where each media service and digital locker service can have their own metadata descriptions as how to define their media assets. One can translate such proprietary metadata descriptions into other metadata using XML translation tables or other metadata translation techniques.

TABLE 1 below describes an example of a media service such as a social networking service or an media asset delivery service. TABLE 2 gives examples of different identifying information that can be used for identifying a media asset. TABLE 4 describes various parameters for a media asset. TABLE 5 describes various fields for the location or modality for the transmission of a media asset. TABLE 6 describes various parental assignments for a media asset. TABLE 7 describes various fields for offers that can be made for a media asset.

TABLE 1

| | |
|---|---|
| <<SERVICE ID> | This field represents a particular social networking |
| | service or other messaging medium that can be used. |
| &FACEBOOK | Facebook |
| &TWITTER | Twitter |
| &LINKEDIN | Linked-In |
| &FLICKER | Flicker Photo Sharing |
| &QZONE | Q-Zone |
| &MYSPACE | MySpace |
| &BEBO | Bebo |
| &SMS | Text Messaging Service |
| &USERNAME | User Name of a person using a social networking |
| | service |

TABLE 2

| | |
|---|---|
| <<ASSETID>> | This field represents the “name” of the media |
| | asset which is used for identifying the particular |
| | asset |
| &UUID | A universal unique identifier that is used for |
| | the media asset. This can be a unique MD5, |
| | SHA1, other type of hash, or other type of |
| | identifier such as Entertainment Identifier |
| | Registry (EIDR). |
| &NAME | A text name for the media asset |
| &TIME | Time that a media asset is being accessed. This |
| | information can be seconds, hours, days, day of |
| | the week, date, and other time related information |
| &ASSETCOMPLETE | The % of completion in the consumption of an |
| | asset |

The term media asset (as described below for TABLE 3) can be: a video based media, an audio based media, a television show, a movie, an interactive service, a video game, a HTML based web page, a video on demand, an audiovideo broadcast, a radio program, advertisement, a podcast, and the like.

TABLE 3

| | |
|---|---|
| <<ASSETTYPE> | This field represents the type of asset that is |
| | being communicated to a user of a social networking |
| | website. |
| &VIDEO | Video based asset |
| &AUDIO | Audio based asset |
| &PHOTO | Photo based asset |
| &TELEVISION | Television show asset which can be audio, video, or |
| | a combination of both |
| &MOVIE | Movie asset which can be audio, video, or a |
| | combination of both |
| &HTML | HTML based web page |
| &PREVIEW | Trailer which can be audio, video, or a combination |
| | of both |
| &ADMOVE | Advertisement asset - expected to be video and/or |
| | audio based such as a flash animation, H.264 video, |
| | SVC video, and the like. |
| &ADSTAT | Advertisement asset - expected to be a static image |
| | such as a JPG, PNG, and the like that can be used |
| | as a banner ad |
| &TEXT | Text Message |
| &RADIO | An audio asset that comes from terrestrial and/or |
| | satellite radio |
| &GAME | Game asset. |
| &INTERACTIVE | An interactive based media asset |
| &PODCAST | Podcast that is audio, video, or a combination of both |
| &APPLICATION | Indicates that a user utilized a particular type of |
| | application or accessed a particular service |
| &EBOOK | Electronic book. |

TABLE 4

| | |
|---|---|
| <<PERMISSONS> | This field represents the various permissions for a |
| | particular asset. |
| &DRMASSET | Digital Rights Management (DRM) scheme used for |
| | a particular asset. Various DRM schemes include |
| | CSS, AACS, DVB-CPCM, FAIRPLAY, |
| | PLAYMEDIA, WIDEVINE, MARLIN, CMLA- |
| | OMA, FLASH ACCESS, and the like. |
| &LICENSE | The license information that can be used for the |
| | playback of a media asset. |
| &DEVICE | Information about the consumption device that is |
| | used for consuming a particular media asset. This |
| | can be information such as a Media Access Control |
| | ID, IP address, physical address information, |
| | logical address information, and the like. |
| &FULLRECORD | Allows an asset to be fully recorded to a user's |
| | device. |
| &NORECORD | Prevents an asset from being recorded to a user's |
| | device. |
| &FULLVIEW | Allows a user to fully consume a media asset. |
| &TIMEVIEW | A parameter that limits a user's consumption of an |
| | asset to a predetermined amount of time. This |
| | parameter can be followed by a numeric value |
| | indicating how many seconds the asset can be |
| | viewed. |
| &TIMEEXPIRE | A parameter that indicates when a user's ability to |
| | consume device expires. This value can be followed |
| | by two numeric values that indicate the date the |
| | asset expires and the particular time of day (GMT |
| | format) |
| &FRAME | A parameter that specifies that only a frame from a |
| | particular asset is to be viewed, such as a still |
| | image. A numeric value can be used to specify a |
| | particular frame. Alternatively, a numeric value |
| | representing a time code which indicates where in |
| | the asset the frame is supposed to be generated. |
| &INTERVAL | A parameter that indicates a particular interval in a |
| | media asset that a user can access. This attribute can |
| | be two numeric values indicating different frame |
| | numbers of the video asset. This attribute can also |
| | be two numeric values representing time codes for a |
| | particular media asset. The first value being the start |
| | of the interval and the second value being the end of |
| | the interval. |
| &HIGH | A parameter that indicates that a high definition |
| | version of an media asset is to be available |
| &LOW | A parameter that indicates that a low definition |
| | version of a media asset is to be available. |

TABLE 5

| | |
|---|---|
| <<LOCATION> | This field represents the location of a particular |
| | media asset |
| &URL | The location of a media asset expressed as a uniform |
| | resource locator and/or IP address |
| &PATH\PATH . . . | The location of a media asset expressed as a |
| | particular local or remote path which can have |
| | multiple subdirectories. |
| &REMOTE | The location of a media asset in a remote |
| | location which would be specified by text after |
| | the remote attribute. |
| &LOCAL | The location of a media asset in a local location |
| | which would be specified by text after the remote |
| | attribute. |
| &BROADCAST | The location being a broadcast source such as |
| | satellite, broadcast television channel, cable |
| | channel, radio station, and the like |
| &BROADCASTID | The identifier of the broadcast channel used for |
| | transmitting a media asset, and the like |
| &SERVICE | Identification of a service for which a media |
| | asset can originate (as a content source or |
| | content provider). Examples of different |
| | services include HULL, NETFLIX, VUDU, |
| | and the like. |
| &LOCKER | Identification of a digital locker service used |
| | in which a media asset can be placed and/or the |
| | rights to use a media asset is specified. Different |
| | examples of lockers include DROPBOX, |
| | ULTRAVIOLET, WINDOWS7/ZUNE, ICLOUD, |
| | EC-2 (Amazon), FACEBOOKMEDIA, |
| | GOOGLEMEDIA, WALCLOUD (Wal-Mart |
| | generic name), BESTCLOUD (Best-Buy |
| | generic name), KEYCHEST, STEAM |
| | (computer game service), and the like. |

TABLE 6

| | |
|---|---|
| <<PARENTALRATING>> | Parental Rating Information that is used to |
| | rate a particular media asset. Different |
| | parental ratings that can be used include Y, |
| | Y7, G, PG, 14 and MA. Other systems can |
| | be used. |
| <<CONTENTRATING> | A content rating that assigns a particular |
| | value to a media asset which is the critic |
| | rating of content. Typically, this is denoted |
| | as how many stars a movie has received. |
| | Other numeric values (0-100) or letter grades |
| | (A, B, C, D and F) can be used as well. |

TABLE 7

| | |
|---|---|
| <<IPRICE>> | A price from a content provider for a specific |
| | media asset. |
| <<SPRICE> | A price for a collection of assets that |
| | encompass more than one media asset |
| | (a series). |
| <<ASSETDISCOUNT>> | A discount which lowers the price that a non- |
| | consuming user can pay if a plurality of media |
| | assets are purchased. |
| <<USERDISCOUNT>> | A discount that is applied if a non-consuming |
| | user purchases/locks on to subscriptions and/or |
| | assets from a plurality of users. |

FIG. 1 is an exemplary embodiment of a media delivery/consumption system 100. Media assets such as movies, television shows, music, video games, e-books, videos, podcasts, and the like can be stored in multiple areas in system 100. Remote media server 102 can be a server that is used to store such media which can be downloaded or streamed to consumption devices 150, 160. Media server 102 can interoperate with license server 112 to have various DRM/license information that permits consumption devices 150, 160 to playback effectively media that is protecting such schemes. Media server 102 can also be implemented as an over the top (OTT) and/or media on demand (NETFLIX, PANDORA, and the like) service where the same media title can be delivered in different formats to different consumption devices 150, 160. Digital locker 104 (such as (CLOUD, EC-2, ULTRAVIOLET, KEYCHEST, and the like) acts as another form of a media repository where media assets are located for eventual downloading/streaming to consumption devices 150, 160. In the case of a digital locker 104, it can be that the locker itself apportions the delivery of a media asset from a plurality of the servers under the control of locker service 104, instead of having to access a specific server. The authorization for the playback of a media asset can be authorized through the use of a license server 114 when digital locker 104 is delivering the asset. Note, multiple digital lockers 104 are shown in FIG. 1 as representing the possibility of having multiple storage locations for media assets which can exist with local media storage 140.

It is anticipated that license servers 112, 114 can use the same DRM schemes, different DRM schemes, or support multiple DRM schemes as supported in the ULTRAVIOLET digital locker setting, for example. Such license servers can also be implemented to coordinate various locker services when a digital locker 104 is implemented in the form of a digital rights management service. For example, digital locker 104 can be the repository of media assets while the permissions to utilize such a media asset is coordinated through license server 114 and consumption devices 150, 160. Likewise, license server 112 and remote media service 102 can be implemented as a digital locker implemented as a digital rights management service.

Media usage database 120 coordinates the usage information that can be tracked when a user operates consumption device 150, 160. The usage information can indicate attributes such as what media asset was consumed, if and when a media asset was purchased, where was the media asset located, what digital locker service was the media asset associated with if applicable, what media device consumed the media asset, and how long was the media asset consumed. Such information can be determined by using an Application Program Interface (API) that can be deployed on a consumption device (150, 160), through a media server (102), digital locker (104), license server (112, 114), and the like. Media usage database through the use of such an API can track the playback of a media asset that is stored within a consumption device 150, 160 and/or a local media server/storage 140 and delivered through digital locker 104. Media usage database 120 can be used to develop a user profile of a user based on the usage of media assets by such a user.

Media usage database 120 can also be implemented to recognize the various media assets that a user has stored and/or accessd as shown in FIG. 1. For example, media usage database is configured to query a digital locker 104 for the media assets that are stored or made available through the locker. Likewise, media usage database 120 can query servers 102 and 140 to inquire about the media assets that are stored in such servers. Optionally, media usage database 120 can request consumption devices 150 and 160 for the presence of media content located in such devices as well. In an optional embodiment, consumption devices 150 and 160 can be configured to make the queries instead of media usage database 120.

The recognition of media assets by media usage database 120 can also be further enhanced by the database being implemented to extract metadata from identified media assets. That is, the media usage database 120 can process ID tags, text files, and the like that can be embedded within a media asset which identifies attributes about the media asset which can be further enhanced by using metadata database 180 which can contain additional information about the media asset.

Offer database 130 contains various offers that can be presented to a user of consumption devices 150, 160 based on the data obtained from the usage of media consumed on such devices, the presence of media assets stored in digital locker 104, and the use of media assets used through digital locker 104. Offers can be constructed based on the media usage data present in database 120. In an optional implementation, offer database 130 can be combined as a content broker 130 that coordinates the purchase and/or delivery of content from different sources such as media server 102, digital locker 104, and the like for consumption devices 150, 160. Alternatively, offer database 130 and the content broker can be different components. Content broker 130 can be implemented such that the broker coordinates the licenses between consumption device 150, 160 and license servers 112, 114 regardless if content is stored locally (in local media server 140) or remotely (server 102, digital locker 104).

Consumption devices 150, 160 can be and not limited to devices such as a personal computer, PDA, set-top box, tablet, television set, video game system, cellular phone, smart phone, or other type of media device that is used for consuming content. It is anticipated that consumption devices 150 and 160 are operated by the same user, whereby through the use of a digital locker service, a media asset, once associated with a particular user, can be played back to a consumption device linked with such a user. That is, a media asset can be delivered to different consumption devices in different forms (for example, a video media asset can be delivered in different encoded formats) as long as such a media asset is associated with the user's media locker. The same situation can apply when an OTT service that makes use of a server 102 or digital locker 104 to deliver media assets. Local server 140 can also operates as a local storage device (network attached storage, hard drive, disk device, solid state memory, and the like) where media assets can be stored for playback to consumption devices 150, 160.

Media database 180 can be a database that is used to obtain more information about a media asset that is played back on a consumption device 150, 160. Such a look up can be performed by using the universally unique identifier (UUID), Entertainment Identifier Registry (EIDR), and/or media ID name that associated with the media asset. Such information can be used then by media usage database 120 to determine which offers to provide to a user when consuming media by using offer database 130. Media assets and their associated metadata can be derived from metadata present in media assets, from external sources such as media database 180, search engines, dictionaries which reference an ID against metadata fields, and the like.

Media database 180 can also be used for classifying media assets based on the associated metadata of such media assets. That is, metadata can be used to group metadata assets based on similar attributes which can include categories such as a file type, topic, studio, actor, character, director, genre, director, broadcast network, and the like. For example, a first media asset stored in a digital locker 104 can be a JAMES BOND movie which has the actor SEAN CONNERY. A second media asset stored in another digital locker 104 (in another location) is a JAMES BOND movie which stars ROGER MOORE. A comparison of such media assets by media database 180 would classify both media assets as being associated with “JAMES BOND” movies where such media assets can be grouped together with such a designation. A third media asset however can be a HIGHLANDER movie which stars SEAN CONNERY. If the described classification operation was to be performed for the first and third media assets, such assets would be grouped together as being movies that star SEAN CONNERY. Multiple classifications can be presented within media database 180 to perform the classification operation in accordance with the described principles.

Additional media assets can then be added automatically to a digital locker 104 based on such additional media assets having the same classification as other media assets already present in such a digital locker. Hence, in the example presented above additional content with a classification of JAMES BOND such as trailers, soundtracks, electronic books, and the like can be automatically added to a digital locker 104 based on such a classification operation. The additional media assets can be automatically added from sources such as remote media server 102, and stored in a digital locker 104. The digital rights can be offered to a user to access such media assets through a digital rights management system as described above.

In an optional embodiment, a user agrees to have additional media assets added automatically without selecting the media assets to be added ahead of time. The user in this optional embodiment can at some later time specify when the addition of the media assets should stop.

The determination of where additional media assets are to be stored can be determined in a variety of ways. A user profile, as described above, can be used for determining which digital locker 104 or local media storage 140 should store additional media assets (e.g., the digital locker 104 used the most is the storage area in which additional media assets are stored). A user profile can also designate that media assets with a classification such as MOVIES are automatically stored in a first storage location such as digital locker 104 or local media storage 140 while media assets with a second classification such as TELEVISION SHOWS are stored in a second storage location such as a second digital locker 104. Other variations of such storage operations can be implemented in accordance with the described illustrative principles. Sample metadata fields and the like as shown in TABLE 8 can be used with the described illustrative embodiments.

TABLE 8

| METADATA FIELD | Description of field. |
|---|---|
| /NAME | Name of a person. In the form of |
| | FIRSTNAME “SPACE” LASTNAME |
| /BIRTHPLACE | Birthplace of a person. In the form of CITY |
| /MOVIEROLE | Name of a character in a movie. In the |
| | form of MOVIE “-” FIRSTNAME “SPACE” |
| | LASTNAME |
| /MACTOR | Actor playing a specific role in a movie. In |
| | the form of (the actor's) FIRSTNAME |
| | “SPACE” LASTNAME “-” (character's) |
| | FIRSTNAME “SPACE” LASTNAME |
| /TELEVISIONROLE | Name of a character in a television show. |
| | In the form of TELEVISION “-” |
| | FIRSTNAME “SPACE” LASTNAME |
| /TACTOR | Actor playing a specific role in a television |
| | show. In the form of (the actor's) |
| | FIRSTNAME “SPACE” LASTNAME “-” |
| | (character's) FIRSTNAME “SPACE” |
| | LASTNAME |
| /DIRECTOR | Director of a movie or television show. In |
| | the form of FIRSTNAME “SPACE” |
| | LASTNAME |
| /MMUSIC | Music selection associated with a movie or |
| | television show. In the form of MOVIE “-” |
| | MUSICGROUP “-” SONGTITLE |

Turning now to FIG. 2, a block diagram of an embodiment of a consumption device 200 is shown. Consumption device 200 can operate similar to the devices such as a computer, set top box, tablet, television, phone, gateway, and the like. Consumption device 200 shown can also be incorporated into other systems including an audio device or a display device. In either case, several components necessary for complete operation of the system are not shown in the interest of conciseness, as they are well known to those skilled in the art.

In the device 200 shown in FIG. 2, content is received by an input signal receiver 202. The input signal receiver 202 can be one of several known receiver circuits used for receiving, demodulation, and decoding signals provided over one of the several possible networks including over the air, cable, satellite, Ethernet, fiber and phone line networks. The desired input signal can be selected and retrieved by the input signal receiver 202 based on user input provided through a control interface or touch panel interface 222. Touch panel interface 222 can include an interface for a touch screen device. Touch panel interface 222 can also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 can provide a digital signal to an audio output device or display device using a High-Definition Multimedia Interface (HDMI) cable or alternate audio interface such as via a Sony/Philips Digital Interconnect Format (SPDIF). The audio interface can also include amplifiers for driving one more sets of speakers. The audio processor 206 also performs any necessary conversion for the storage of the audio signals.

The video output from the input stream processor 204 is provided to a video processor 210. The video signal can be one of several formats. The video processor 210 provides, as necessary, a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 can be a hard disk drive, one or more large capacity integrated electronic memories, such as static RAM (SRAM), or dynamic RAM (DRAM), or can be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 can be an analog signal interface such as red-green-blue (RGB) or can be a digital interface such as HDMI. It is to be appreciated that the display interface 218 will generate the various screens for presenting the search results in a two dimensional form as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 can interface with search engine 105 for the searching of content and the creation and adjusting of the display of graphical objects representing such content which can be stored or to be delivered via content server 110, described above.

The controller 214 is further coupled to control memory 220 (e.g., volatile or nonvolatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 can store instructions for controller 214. Control memory can also store a database of elements, such as graphic elements containing content, various graphic elements used for generating a displayed user interface for display interface 218, and the like. Alternatively, the memory can store the graphic elements in identified or grouped memory locations and use an access or location table to identify the memory locations for the various portions of information related to the graphic elements. In addition, various graphic elements can be generated in response to computer instructions interpreted by controller 214 for output to display interface 218. Further, the implementation of the control memory 220 can include several possible embodiments, such as a single memory device or, alternatively, more than one memory circuit communicatively connected or coupled together to form a shared or common memory. Still further, the memory can be included with other circuitry, such as portions of bus communications circuitry, in a larger circuit.

Optionally, controller 214 can be adapted to extract metadata from audio and video media by using audio processor 206 and video processor 210, respectively. That is, metadata that is contained in video signal in the vertical blanking interval, auxiliary data fields associated with video, or in other areas in the video signal can be harvested by using the video processor 210 with controller 214 as to generate metadata that can be used for functions such as generating an electronic program guide, have descriptive information about received video, supporting an auxiliary information service, and the like. Similarly, the audio processor 206 working with controller 214 can be adapted to recognize audio watermarks that can be in an audio signal. Such audio watermarks can then be used to perform some action such as the recognition of the audio signal, security which identifies the source of an audio signal, or perform some other service. Furthermore, metadata to support the actions listed above can come from a network source which are processed by controller 214.

Controller 214 can be also configured to process user interface information and to filter communications and content received from different sources based on the context, subject, topic, and the like of such communications and content where not all of the communications/context received will be displayed based on filtering techniques. For example, if a received communication is from a specific source of a particular context/subject, such a communication can be displayed or further relayed if such the source and subject are specified in user profile information, in accordance with the disclosed principles. Other filtering options can be implemented in accordance with the exemplary embodiments.

Turning now to FIG. 3, the user interface process of the present disclosure employs an input device that can be used to express functions, such as fast forward, rewind, etc for generating user input. To allow for this, a tablet or touch panel device 300 on a consumption device can be interfaced via the user interface 216 and/or touch panel interface 222 of the receiving device 200. The touch panel device 300 allows operation of the receiving device or set top box based on hand movements, or gestures, and actions translated through the panel into commands for the set top box or other control device. In one embodiment, the touch panel 300 can simply serve as a navigational tool to navigate the grid display or means that controls a second device via a user interface. In other embodiments, the touch panel 300 will additionally serve as the display device allowing the user to more directly interact with the navigation through the grid display of content. The touch panel device can be included as part of a remote control device containing more conventional control functions such as activator buttons. The touch panel 300 can also include at least one camera element. Note, various touch panel interface 222, buttons, softkeys, trackballs, stylus, touchpads, and the like can operate as an input interface providing a user the ability to control elements shown as part of user interface 216.

FIG. 4 is a flowchart of an exemplary method for classifying media assets stored in different locations. Step 405 begins with the extraction of metadata from a first media asset located in a first storage location such as a first digital locker 104. Step 410 continues with the extraction of metadata from a second media asset located in a second storage location such as a second digital locker 104, local media storage 140, consumption device 150, consumption device 160, and the like. The extracted metadata from the first and second media assets are compared in step 415. The results of the comparison step 415 results in a common classification being assigned to the first and second media asset in step 420. Various methods of classifying metadata are described herein referencing the use of metadata database 180 and are not to be limited.

In an optionally performed step 425, offers are made to a user to get a third media asset where such offers are selected based on the classification assigned in step 420. That is, instead of offers being limited to a specific service or based on what is stored in a specific location, the described illustrative principles can be used to provide offers to a user based on the media content a user has stored and has access when such media assets are stored in multiple locations.

The following serve as different examples of offers that can be delivered to a user in the use of remote media server 102, digital lockers 104, local media server 140, consumption device 150 and consumption device 160. The implementation of such examples can be performed through the information learned through media usage database 120 and offer database 130, with a content broker optionally coordinating such offers.

A first example takes place when a particular content provider such as a movie studio or broadcast network wants to promote the purchase of their content, but lacks the means of determining who has purchased what content and where such content resides. By using the information determined from the media rights database 120, it is possible that a content studio or broadcast network creator can learn set up an offer that for every “X” number of media assets purchased for which the content studio or broadcast network created, a user will be able to get an additional media asset for a reduced price and/or for free. For instance, a user purchases two movie media assets that available through a digital locker 104. The user then purchases a third movie media asset through a content provider that stores content on server 102, where all of the movies are classified as being from the same movie studio. An offer can be presented to the user because three titles (X=3 in this example) were purchased and such media titles have the same classification (i.e., same movie studio, the user can acquire a fourth media asset for free and the user can specify where the digital media asset is to be stored and what digital asset will be purchased. By using the elements of content broker 130, the coordination of the offer can be set up by the architecture of the content broker via server 102, service 104, or other content provider in which content broker 130 can coordinate purchases and the delivery of such a digital asset.

A second scenario exists where an offer can be delivered to a user depending on the consumption device that they are using. Hence, an offer for free or reduced priced digital media asset can be offered to a user to push the consumption of a media asset on a second device. For example, a user plays a video game using consumption device 150, whereby such information is tracked in media usage database 120. An offer can be made to the user to buy or to preview a movie media asset which can be played back on consumption device 160 because the media usage of the user is tracked and the media usage database can also track what devices a user owns and/or has registered. This lookup can also be performed by referring to digital locker 104 data where a user registers specific devices for the playback of media. This also allows for different types of digital media that typically are not associated with each other which come from disperse content providers to be unified when offers are being shown to a user.

A third example presented allows for when a user operates a consumption device where the media consumed is either from a source that is local (media server 140) and/or is received from a broadcast source such as a television station, cable provider, IPTV stream, satellite broadcast, personal video recorder, and the like. The reference to the media from any of these sources can be monitored using the techniques described above with media usage database 120 with additional lookups with database 180 (for extra information about the media that may not be as part of the media). The consumption of the content in either of these settings can also promote the use to the use of a digital locker in several different ways.

A fourth example provides an offer based on the digital locker 104 used to consume a media asset and on the consumption device 150 or consumption device 160 used for the consumption. From this activity, media usage database 120 develops media usage information including the movie, what device was used to consume the movie, and when the movie was consumed by the user. This information is then referenced in offer database 130 which matches up to a promotion for a user to try out a digital locker service, where the digital locker can be populated with a version of the movie that watched. Alternatively, the offer can populate (for free or for a discount) digital locker 104 with other types of media such as the sequel to the movie watched, music from the movie, a game related to the movie, auxiliary information about the movie, and the like in order to induce a user to start using the digital locker 104 where the added media has the same classification as other media stored in the digital locker 104. Other offers are possible in accordance with the described principles.

In step 430, a third media asset can be automatically added to a first or second storage locations where the third media asset has a classification that is the same as the first and second media asset. There is not a limit to the amount of media assets with similar classifications that can be added to the first or second storage locations. The determination of what location to store the third media asset to can be determined in accordance with a user profile in step 435 where the user profile can specify a specific storage location, a storage location can be selected based on frequency of use of such locations, the category of a media asset can be mapped to a specific storage location (e.g., sports assets in a first locker 104 and television assets in a second locker 104), and the like.

Step 440 is implemented using the principles described above of by classifying a fourth media asset stored in the first storage location and a fifth media asset stored in the second storage location with a second common classification. In step 445, a sixth media asset with the second common classification can be stored in the first or second storage location automatically in accordance with the principles described above.

FIG. 5 illustrates an exemplary user interface showing various media assets in accordance with the described principles. Specifically, the user interface 500 shows an element comporting to media asset 505 which is located in a first storage location such as digital locker 104. An element comporting to media asset 510 is represented as being located in the first storage location as well. Likewise, media assets 515 and 520 are shown as being stored in a second storage location.

FIG. 6 illustrates an exemplary user interface showing the results of the classification in accordance with the described principles. That is, after performing classification operations as described above, media asset 505 and media asset 515 are determined to share the same classification of JAMES BOND and are grouped accordingly. In addition, a media asset 525 is shown as being added to the group as media asset 525 shares the same classification as media assets 505 and 515. The location where media asset 525 will be stored can be determined in accordance with the principles described in the presented illustrative embodiments.

Likewise, media asset 510 and media asset 520 are shown to share the common classification of HIGHLANDER and are grouped together accordingly. Media asset 530 is shown as being added to the HIGHLANDER group as media asset 530 shares the same classification as media assets 510 and 520. The location where media asset 530 will be stored can be determined in accordance with the presently described principles. Other classifications can be used depending on the presence of different media assets. For example, one grouping of media assets can share a common director, common actor, common genre, movie studio, broadcast network, subject, and the like.

It should be understood that the elements shown in the figures can be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. It is noted that modifications and variations can be made by persons skilled in the art in light of the above teachings.

1. A method of adding media files to a storage location comprising the steps of:
assigning (420) a classification to a first media asset stored in a first location and a second media asset stored in a second location where said classification is based on metadata associated with said first and second media asset; and
adding a third media asset (430) having said classification to at least one of said first storage location and said second storage location.

2. The method of claim 1 where said assigning step additionally comprises the steps of:
extracting metadata embedded within said first media asset;
extracting metadata embedded within said second media asset; and
comparing said metadata from said first media asset and said metadata from said second media asset by using a database that groups metadata into a plurality of classifications.

3. The method of claim 2 where said classification is selected automatically from a plurality of classifications based on a user profile.

4. The method of claim 1 where said location in which said third media asset is added is selected in accordance with a user profile.

5. The method of claim 4 where said third media asset is selected from a plurality of media assets in view of said user profile.

6. The method of claim 1 comprising the steps of:
presenting an offer from a plurality of offers to be presented to a user based on said classification step: and
said third media asset is added in response to said presented offer.

7. The method of claim 1 wherein said classification is at least one of a file type, topic, studio, actor, character, director, genre, director, and broadcast network.

8. The method of claim 1 comprising the additional steps of:
assigning a second classification to a fourth media asset stored in said first location and a fifth media asset stored in said second location where said second classification is based on metadata associated with said fourth and fifth media asset; and
adding a sixth media asset having said second classification to at least one of said first storage location and said second storage location.

9. A method of generating a user interface comprising:
generating a displayable signal containing a first element corresponding to a first media asset stored in a first location and a second element corresponding to a second media asset stored in a second location;
updating said displayable signal to show a classification (420) assigned to said first and second media assets based on metadata associated with said first and second media assets; and
updating said displayable signal to show a third element corresponding to a third media asset having said classification (430) where said third media asset is added to at least one of said first storage location and said second storage location.

10. The method of claim 9 additionally comprising the steps of:
extracting metadata embedded within said first media asset;
extracting metadata embedded within said second media asset; and
comparing said metadata from said first media asset and said metadata from said second media asset by using a database that groups metadata into a plurality of classifications.

11. The method of claim 10 where said classification is selected automatically from said plurality of classifications based on a user profile.

12. The method of claim 10 where said location in which said third media asset is added is selected in accordance with a user profile.

13. The method of claim 12 where said third media asset is selected from a plurality of media assets in view of said user profile.

14. The method of claim 10 comprising the steps of:
updating said displayable signal to present an offer from a plurality of offers to be presented to a user based on said classification step: and
said third media asset is added in response to said presented offer.

15. The method of claim 10 wherein said classification is at least one of: a file type, a topic, studio, actor, character, director, genre, director, and broadcast network.

16. The method of claim 10 comprising the additional steps of:
updating said displayable signal to show a second classification assigned to a fourth media asset represented by a fourth element where said fourth media asset is stored in said first location and a fifth media asset represented by a fifth element where said fifth media asset is stored in said second location where said second classification is based on metadata associated with said fourth and fifth media asset; and
updating said displayable signal to show a sixth element representing a sixth media asset having said second classification where said sixth media asset is added to at least one of said first storage location and said second storage location.

17. An apparatus comprising:
a display processor that generates a displayable signal containing a first element corresponding to a first media asset stored in a first location and a second element corresponding to a second media asset stored in a second location;
a controller that determines a classification assigned to said first and second media asset based on metadata associated with said first and second media asset;
said display processor updating said displayable signal to show said classification;
said controller adding a third media asset with said classification that is added to at least one of said first storage location and said second storage location; and
said display processor updating said displayable signal to show the storage location of said third media asset.
